(19) United States
(12) Patent Application Publication
(10) Pub. No.: US 2012/0210061 A1
(43) Pub. Date: Aug. 16, 2012

(54) COMPUTER AND METHOD FOR TESTING REDUNDANT ARRAY OF INDEPENDENT DISKS OF THE COMPUTER

(75) Inventor: CHIH-HUI CHENG, Tu-Cheng (TW)

(73) Assignee: HON HAI PRECISION INDUSTRY CO., LTD., Tu-Cheng (TW)

(21) Appl. No.: 13/315,290

(22) Filed: Dec. 9, 2011

(30) Foreign Application Priority Data
Feb. 11, 2011 (TW) 100104685

(51) Int. Cl. G06F 12/00

(52) U.S. Cl. 711/114; 711/E12.001

(57) ABSTRACT

In a method for testing a redundant array of independent disks (RAID) of a computer, the RAID includes two or more hard disk drives. A RAID volume is created for the RAID. One of the hard disk drives in the RAID is disabled while the RAID volume is in an optimal state. The RAID volume is in a degraded state when one of the hard disk drives in the RAID is disabled. The disabled hard disk drive in the RAID is then enabled while the RAID volume is in the degraded state. Then an attempt to rebuild the RAID volume is made. The RAID works normally once each of the hard disk drives in the RAID is disabled and enabled, and the RAID volume is successfully rebuilt after each enablement and the optimal state is achieved.

### BACKGROUND

1. Technical Field

Embodiments of the present disclosure relate generally to hard disk testing, and more particularly, to a computer and a method for testing a redundant array of independent disks (RAID) of the computer.

2. Description of Related Art

A known RAID testing method of a computer system comprising multiple hard disk drives configured in RAID format requires manual removal of each of the hard disk drives, reinstallation of the hard disk drives, and then testing the hard disk drives. Since the number of the hard disk drives may be numerous, the test demands heavy use of manpower which is expensive and prone to human error.

### BRIEF DESCRIPTION OF THE DRAWINGS

FIG. 1 is a block diagram of one embodiment of a computer including a test system and a RAID.

FIG. 2 is a flowchart of one embodiment of a method for testing the RAID of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

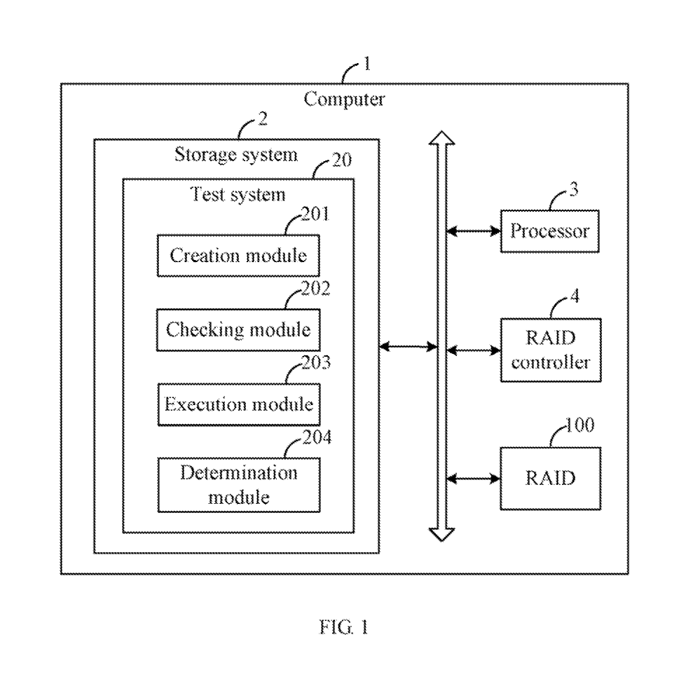

FIG. 1 is a block diagram of one embodiment of a computer 1 including a test system 20 and a redundant array of independent disks (RAID) 100. In the embodiment, the test system 20 is configured to test the RAID 100 that is used for storing data of the computer 1. The RAID 100 includes two or more hard disk drives that are physically connected to each other in a sequence. Depending on the embodiment, the computer 1 further includes a storage system 2, at least one processor 3, and a RAID controller 4. The RAID controller 4 is operable to manage the RAID 100, such as presenting the RAID 100 to the computer 1 as a virtual hard disk drive that is named RAID volume, and checking a state of the RAID volume. It should be apparent that FIG. 1 is just one example of the computer 1, and in other embodiments the computer 1 may include more or fewer components than shown, and in different configurations.

The test system 20 may be in the form of one or more programs stored in the storage system 2 and executed by the at least one processor 3. In one embodiment, the storage system 2 may be random access memory (RAM) for temporary storage of information, and/or a read only memory (ROM) for permanent storage of information. In other embodiments, the storage system 2 may also be an external storage device, such as a hard disk, a storage card, or a data storage medium. The at least one processor 3 executes computerized operations of the computer 1 and other applications, to provide functions of the computer 1.

In the embodiment, the test system 20 creates the RAID volume for the RAID 100 via the RAID controller 4 in the computer 1. The process of creating the RAID volume may include selecting an array mode, selecting hard disk drives, and setting stripe size, for example. The RAID volume is in an optimal state when all of hard disk drives in the RAID 100 work normally, but the RAID volume is in a degraded state when one of the hard disk drives in the RAID 100 is corrupted or disconnected from the RAID 100. The data in the RAID 100 may be at risk when the RAID volume is in the degraded state. The RAID volume can be rebuilt in order to recover the data in the RAID 100 when the RAID volume is in the degraded state. The process of rebuilding the RAID volume is the same as the process of creating the RAID volume. The RAID level of the RAID 100 may be RAID 5.

In the embodiment, the test system 20 can selectively, via a computerized command, electronically disconnect and reconnect the hard disk drives to and from the RAID 100 to simulate hard disk drive disablement and enablement. The RAID volume is in the degraded state each time one of the hard disk drives is disabled by the test system 20. The RAID volume in the degraded state is able to be rebuilt when the disabled hard disk drive is enabled. The RAID volume does not pass the test if the RAID volume cannot be rebuilt after disabling and enabling any one of the hard disk drives.

The test system 20 may include a plurality of functional modules each comprising one or more programs or computerized codes that can be accessed and executed by the at least one processor 3. The test system 20 may include a creation module 201, a checking module 202, an execution module 203, and a determination module 204. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The creation module 201 is operable to create a RAID volume for the RAID 100 via the RAID controller 4 in the computer 1. The process of creating the RAID volume may include selecting an array mode, selecting hard disk drives, and setting stripe size, for example.

The checking module 202 is operable to check whether the RAID volume is in an optimal state via the RAID controller 4 when the RAID volume is created. The checking module 202 determines that the RAID 100 does not work normally if the RAID volume is not in the optimal state when the RAID volume is created.

The execution module 203 is operable to send a disabled command to the RAID 100 for disabling one of the hard disk drives in the RAID 100 when the RAID volume is in the optimal state.

The checking module 202 is further operable to check whether the RAID volume is in the degraded state when the hard disk drive in the RAID 100 is disabled. Because the RAID controller 4 can check the state of the RAID volume, the checking module 202 can check whether the RAID volume is in the degraded state via the RAID controller 4. Once the checking module 202 determines the RAID volume is in the degraded state it notifies the execution module 203 of the degraded state.

The execution module 203 is further operable to send an enabled command to the RAID 100 for enabling the disabled hard disk drive in the RAID 100 when the RAID volume is in the degraded state.

The creation module 201 is further operable to rebuild the RAID volume for the RAID 100 via the RAID controller 4 when the disabled hard disk drive is enabled. The process of rebuilding the RAID volume is the same as the process of creating the RAID volume.

The checking module 202 is further operable to check whether the RAID volume is in the optimal state via the RAID controller 4 when the RAID volume is rebuilt. The checking module 202 determines that the RAID 100 does not work normally if the RAID volume is not in the optimal state when the RAID volume is rebuilt.

The determination module 204 is operable to determine whether each of the hard disk drives in the RAID 100 has been processed (including disabled and enabled) when the rebuilt RAID volume is in the optimal state. If each of the hard disk drives in the RAID 100 has not been processed, the execution module 203 processes a next hard disk drive in the RAID 100. The creation module 201 rebuilds the RAID volume when one of the hard disk drives in the RAID 100 has been processed, and the checking module 202 checks whether the RAID volume is in the optimal state. If each of the hard disk drives in the RAID 100 has been processed, the determination module 204 determines that the RAID 100 works normally.

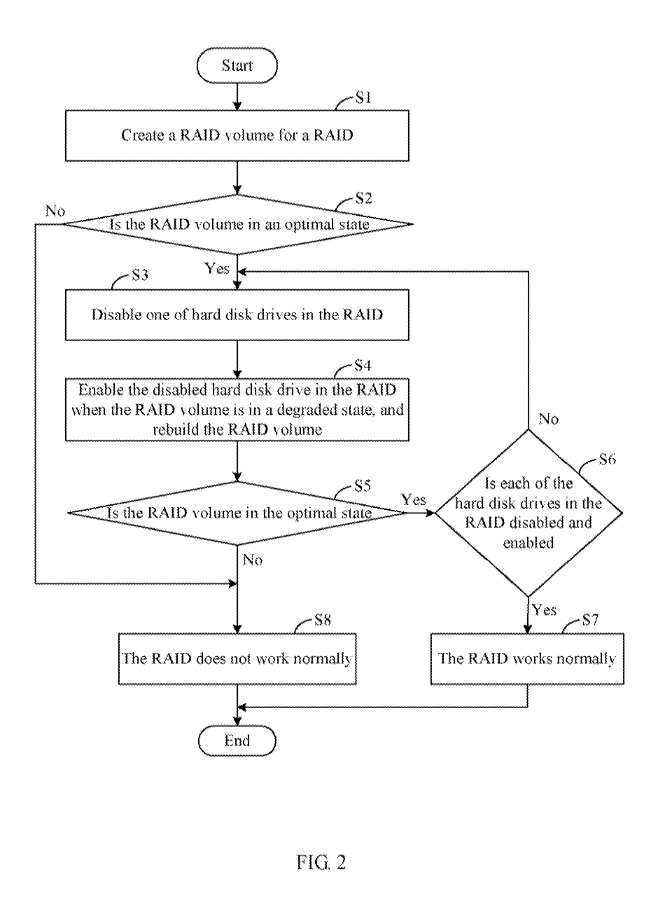

FIG. 2 is a flowchart of one embodiment of a method for testing the RAID 100 of FIG. 1. Depending on the embodiment, additional blocks may be added, others removed, and the ordering of the blocks may be changed.

In block S1, the creation module 201 creates a RAID volume for the RAID 100 via the RAID controller 4 in the computer 1.

In block S2, the checking module 202 checks whether the RAID volume is in the optimal state via the RAID controller 4 when the RAID volume is created. If the RAID volume is in the optimal state when the RAID volume is created, block S3 is implemented. If the RAID volume is not in the optimal state when the RAID volume is created, block S8 is implemented.

In block S3, the execution module 203 sends a disabled command to the RAID 100 for disabling one of the hard disk drives in the RAID 100.

In block S4, the checking module 202 checks whether the RAID volume is in the degraded state via the RAID controller 4, the execution module 203 sends an enabled command to the RAID 100 for enabling the disabled hard disk drive in the RAID 100 when the RAID volume is in the degraded state, and the creation module 201 rebuilds the RAID volume for the RAID 100 via the RAID controller 4.

In block S5, the checking module 202 checks whether the RAID volume is in the optimal state via the RAID controller 4 when the RAID volume is rebuilt. If the RAID volume is in the optimal state when the RAID volume is rebuilt, block S6 is implemented. If the RAID volume is not in the optimal state when the RAID volume is rebuilt, block S8 is implemented.

In block S6, the determination module 204 determines whether each of the hard disk drives in the RAID 100 has been processed (including disabled and then enabled). If each of the hard disk drives in the RAID 100 has not been processed, block S3 is repeated until all the hard disk drives in the RAID 100 have been processed. If each of the hard disk drives in the RAID 100 has been processed, block S7 is implemented.

In block S7, the determination module 204 determines that the RAID 100 works normally.

In block S8, the determination module 204 determines that the RAID 100 does not work normally.

All of the processes described above may be embodied in, and fully automated via, functional code modules executed by one or more general purpose processors of the computing devices. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
a storage system;
at least one processor;
a redundant array of independent disks (RAID) comprising two or more hard disk drives;
one or more programs stored in the storage system and executed by the at least one processor, the one or more programs comprising:
a creation module operable to create a RAID volume for the RAID;
a checking module operable to check whether the RAID volume is in an optimal state when the RAID volume is created;
an execution module operable to disable one of the hard disk drives in the RAID when the RAID volume is in the optimal state;
the checking module further operable to check whether the RAID volume is in a degraded state when the hard disk drive in the RAID is disabled;
the execution module further operable to enable the disabled hard disk drive in the RAID when the RAID volume is in the degraded state;
the creation module further operable to rebuild the RAID volume for the RAID when the disabled hard disk drive in the RAID is enabled;
the checking module further operable to check whether the RAID volume is in the optimal state when the RAID volume is rebuilt; and
a determination module operable to determine that the RAID works normally when each of the hard disk drives in the RAID has been disabled and enabled, and the rebuilt RAID volume is in the optimal state.

2. The computer of claim 1, further comprising a RAID controller that is operable to manage the RAID.

3. The computer of claim 2, wherein the creation module creates or rebuilds the RAID volume for the RAID via the RAID controller.

4. The computer of claim 2, wherein the checking module checks whether the RAID volume is in the optimal state or the degraded state via the RAID controller.

5. The computer of claim 1, wherein the execution module disconnects one of the hard disk drives from the RAID for disabling the hard disk drive by sending a disabled command to the RAID, and reconnects the disabled hard disk drive to the RAID for enabling the disabled hard disk drive by sending an enabled command to the RAID.

6. The computer of claim 1, wherein the checking module determines that the RAID does not work normally upon the condition that the RAID volume is not in the optimal state when the RAID volume is created or rebuilt.

7. A method for testing a redundant array of independent disks (RAID) of a computer, the method comprising:
(a) creating a RAID volume for the RAID, the RAID comprising two or more hard disk drives;
(b) checking whether the RAID volume is in an optimal state when the RAID volume is created;
(c) disabling one of the hard disk drives in the RAID when the RAID volume is in the optimal state;
(d) checking whether the RAID volume is in a degraded state when the hard disk drive in the RAID is disabled;
(e) enabling the disabled hard disk drive in the RAID when the RAID volume is in the degraded state;
(f) rebuilding the RAID volume for the RAID when the disabled hard disk drive in the RAID is enabled;
(g) checking whether the RAID volume is in the optimal state when the RAID volume is rebuilt;
(h) determining that the RAID works normally when each of the hard disk drives in the RAID has been disabled and enabled, and the rebuilt RAID volume is in the optimal state.

8. The method of claim 7, wherein the RAID volume is created or rebuilt via a RAID controller of the computer.

9. The method of claim 8, wherein the optimal or degraded state of the RAID volume is checked via the RAID controller.

10. The method of claim 7, wherein the block (c) comprises disconnecting one of the hard disk drives from the RAID for disabling the hard disk drive by sending a disabled command to the RAID.

11. The method of claim 7, wherein the block (e) comprises reconnecting the disabled hard disk drive to the RAID for enabling the disabled hard disk drive by sending an enabled command to the RAID.

12. The method of claim 7, further comprising:
determining that the RAID does not work normally, upon the condition that the RAID volume is not in the optimal state when the RAID volume is created or rebuilt.

13. A non-transitory storage medium storing a set of instructions, the set of instructions capable of being executed by a processor of a computer, cause the processor to execute a method for testing a redundant array of independent disks (RAID) of the computer, the method comprising:
(a) creating a RAID volume for the RAID, the RAID comprising two or more hard disk drives;
(b) checking whether the RAID volume is in an optimal state when the RAID volume is created;
(c) disabling one of the hard disk drives in the RAID when the RAID volume is in the optimal state;
(d) checking whether the RAID volume is in a degraded state when the hard disk drive in the RAID is disabled;
(e) enabling the disabled hard disk drive in the RAID when the RAID volume is in the degraded state;
(f) rebuilding the RAID volume for the RAID when the disabled hard disk drive in the RAID is enabled;
(g) checking whether the RAID volume is in the optimal state when the RAID volume is rebuilt;
(h) determining that the RAID works normally when each of the hard disk drives in the RAID has been disabled and enabled, and the rebuilt RAID volume is in the optimal state.

14. The storage medium of claim 13, wherein the RAID volume is created or rebuilt via a RAID controller of the computer.

15. The storage medium of claim 14, wherein the optimal or degraded state of the RAID volume is checked via the RAID controller.

16. The storage medium of claim 13, wherein the block (c) comprises disconnecting one of the hard disk drives from the RAID for disabling the hard disk drive by sending a disabled command to the RAID.

17. The storage medium of claim 13, wherein the block (e) comprises reconnecting the disabled hard disk drive to the RAID for enabling the disabled hard disk drive by sending an enabled command to the RAID.

18. The storage medium of claim 13, wherein the method further comprises:
determining that the RAID does not work normally, upon the condition that the RAID volume is not in the optimal state when the RAID volume is created or rebuilt.
